(19) United States
(12) Patent Application Publication
(10) Pub. No.: US 2026/0194204 A1
(43) Pub. Date: Jul. 9, 2026

(54) LIGHTING DEVICE WITH LIGHT DISTRIBUTION BODY

(71) Applicant: PARO Holding GmbH, Starnberg (DE)

(72) Inventor: Axel MEISE, München (DE)

(21) Appl. No.: 19/131,439

(22) PCT Filed: Nov. 21, 2023
(86) PCT No.: PCT/EP23/82497

§ 371 Date: May 20, 2025

(30) Foreign Application Priority Data
Nov. 21, 2022 (DE) 10 2022 130 736.0

(51) Int. Cl. F21V 5/04; F21V 5/00; F21V 7/22; F21Y 115/10

(52) U.S. Cl. CPC F21V 5/041; F21V 3/049; F21V 3/0615; F21K 9/232; F21K 9/61; F21K 9/66; F21Y 2115/10

(57) ABSTRACT

A lighting device is proposed, in particular for illuminating an interior, comprising: a lighting means 3; a light distribution body 1 with a light coupling-in surface 11 and a translucent light exit region 12; wherein the light distribution body 1 is substantially spherical and is designed to emit a first part of the light emitted by the lighting means 3 and introduced into the light distribution body 1 via the light coupling-in surface 11 in a directed manner, and to scatter a second part of the introduced light by means of the light distribution body 1, so that the light emerges in a diffuse manner substantially over the entire light exit region 12 of the light distribution body 1, wherein the light distribution body 1 is of solid design, and wherein the light coupling-in surface 11 is the interface between a recess 6 of the light distribution body 1 and the light distribution body 1.

The present invention relates to a lighting device with a light distribution body according to the subject matter of claim 1.

Lighting devices with different emission characteristics are known, which are each suitable for illumination purposes in different applications. Thus, for example, lighting devices are known which have a diffuse emission characteristic. Such lighting devices are suitable for uniformly illuminating a space over a large area. On the other hand, lighting devices are known which are designed for emitting directed light, such as, for example, spotlights or spotlamps. With such lighting devices, a limited area of space can be illuminated in a targeted manner.

In many cases, it is desired to use both emission characteristics simultaneously for the illumination of a space, for example in workspaces with a workplace. There, it is desirable to be able to uniformly illuminate the space and at the same time to be able to provide increased illumination of the workplace. Likewise, it is frequently desirable to combine a diffuse illumination of the space with a directed illumination of certain areas of space in order to generate a pleasant spatial tuning.

In the prior art, different lights are known which combine different lighting means with different emission characteristics in order to simultaneously generate diffuse and directed light. Thus, for example, DE 20 2016 102 638 U1 discloses a hybrid light which has at least one LED lighting means for emitting a directed luminous flux and at least one planar OLED lighting means for emitting a diffuse luminous flux.

Since the hybrid light requires separate lighting means for providing the different emission characteristics, the space requirement and the outlay during production are increased.

Against this background, the object of the present invention is to specify a lighting device which is suitable for emitting directed and diffuse light. Furthermore, the present invention is intended to specify a lighting device which, despite the possibility of generating directed and diffuse light, is distinguished by a structurally simple and compact, space-saving construction.

The object is achieved by a lighting arrangement with the features of claim 1. Advantageous developments emerge from the dependent claims.

The object is achieved in particular by a lighting device, in particular for illuminating an interior, comprising a lighting means, a light distribution body with a light coupling-in surface and a translucent light exit region. In this case, the light distribution body is substantially spherical. The light distribution body is designed to emit a first part of the light emitted by the lighting means and introduced into the light distribution body via the light coupling-in surface in a directed manner, and to scatter a second part of the introduced light by means of the light distribution body, so that the light emerges in a diffuse manner substantially over the entire light exit region of the light distribution body. The light distribution body is of solid design, wherein the light coupling-in surface is formed at an interface between a recess of the light distribution body and the light distribution body. In this case, the recess comprises a first part, which has the shape of a spherical element, a cone or a flattening, wherein the shape of the first part can be both positive and negative.

An essential concept of the invention is to provide a light distribution body and to configure it in such a way that coupled-in light, which is emitted by a (single) lighting means, is emitted in part in a diffuse manner and in another part in a directed manner from the light distribution body. A structurally simple and space-saving construction of a lighting device having two emission characteristics is thus achieved, since only one lighting means and one (comparatively compact) light distribution body are required. In this case, the geometric configuration of the recess (at which the light coupling-in surface is formed) serves to influence the emission characteristic of the light distribution body in a targeted manner.

In this case, the light distribution body fulfils a dual function. A (first) part of the light coupled into the light distribution body is guided and preferably directed in the interior of the light distribution body in such a way that this part of the light emerges in a directed manner from the light distribution body. Preferably, the directed portion of the coupled-in light emerges via a partial region of the light exit region. A (second) part of the light coupled into the light distribution body is scattered or distributed by means of the light distribution body in such a way that this part of the coupled-in light is emitted in a diffuse manner over substantially the entire light exit region, preferably over the entire light exit region. In this case, the diffusely emitted light is preferably scattered both when emerging from the surface of the light distribution body, which forms the light exit region, and in the case of internal reflections in the interior of the light distribution body. As a result of the internal reflections, the light is additionally distributed in the light distribution body.

Thus, the light distribution body generates a diffuse emission characteristic as a result of the scattering of the one (first) part of the coupled-in light and a directed emission characteristic as a result of the directed emission of the other (second) part of the coupled-in light. The light distribution body is therefore designed according to the invention to emit light which is coupled in via the light coupling-in surface with an emission characteristic which represents a superposition of a diffuse emission characteristic and a directed emission characteristic. Advantageously, in this case, no separate lighting means or optical elements for modifying the emission characteristic are required for providing this emission characteristic.

The lighting device according to the invention has an emission characteristic which represents a superposition of a diffuse emission characteristic and a directed emission characteristic. Thus, with the lighting device according to the invention, a space, in particular an interior, can be illuminated uniformly with a single lighting means and at the same time a limited area of space can be illuminated with the directed light component in a targeted manner.

In the context of the present invention, a diffuse light emission or emission characteristic is to be understood as meaning a spatial emission pattern which has a substantially constant intensity over a large solid angle range, preferably over a solid angle range of 2π sr (steradian) or more. In contrast to this, a directed light emission or emission characteristic denotes a spatial emission pattern in which the emission is limited to a small solid angle range of less than 2π sr, preferably less than 1 sr. A directed light emission is therefore not limited to a collimated light emission, but rather also comprises a cone-shaped emission pattern with a small emission angle of preferably 45° or less.

In order to ensure the light distribution function in the interior of the light distribution body, it is further preferred that the light distribution body is formed from a transparent material, preferably from glass or a transparent plastic. According to the invention, the light distribution body is of solid design (that is to say without cavities) and preferably consists substantially completely of the transparent material.

With such a light distribution body, the directed portion of the emitted light can be realized in a structurally particularly simple manner. Particularly preferred is a light distribution body which is formed by a solid, substantially spherical body made of a transparent material. In this configuration, part of the light introduced into the light distribution body is focused by the substantially spherical light distribution body. This part of the coupled-in light emerges in a directed manner from the light distribution body via a region of the light exit surface of the light distribution body which lies opposite the light coupling-in surface. The directed part of the emission of the coupled-in light can thus be realized in a particularly simple manner with a light distribution body which is geometrically compact and simple to produce.

In this case, it is preferred that the substantially spherical light distribution body has a diameter of more than 5 cm, particularly preferably between 5 cm and 50 cm.

A substantially spherical body is to be understood as meaning a body whose shape deviates only slightly from a spherical shape. For example, ellipsoids in which the difference in the length of the semiaxes is substantially smaller than the length of the shortest semiaxis (preferably, no difference in length of the semiaxes is more than 10% of the length of the shortest semiaxis) are to be understood as being substantially spherical in the context of the present description. In this case, a positive or negative expression is to be understood in each case as meaning that the corresponding geometric figure (the spherical element or the truncated cone) is curved inwards, that is to say is part of the recess (positive expression of the shape), or is curved outwards, and thus forms part of the light distribution body (negative expression of the shape).

Since the recess receives the largest part of a light wavefront emitted by the light distribution body before it enters the light distribution body, the geometric nature of the first part of the recess is of essential importance for the beam profile in the interior of the light distribution body, since the light coupling-in surface, which is formed at the interface between the recess and the light distribution body, refracts the coupled-in light beams. Owing to the fact that the first part of the recess—and thus the light coupling-in surface—lies opposite the region of the light distribution body from which the directed emission takes place, the geometric configuration of the recess—and thus of the light coupling-in surface—has a great influence on the portion of the coupled-in radiation which is emitted in a directed manner.

If the connecting line between the center point of the light distribution body and a central point of the first part of the first recess is defined as the optical axis, for example the selection of the shape of the first part as a spherical element with a positive expression leads to incident beams being refracted away from the optical axis. This leads to the portion of the radiation emitted in a directed manner decreasing relative to the portion of the diffusely emitted radiation. Conversely, a configuration of the shape of the first part as a spherical element with a negative expression leads to the incident beams being refracted towards the optical axis, as a result of which the portion of the radiation emitted in a directed manner increases.

A comparable effect, although different in quantitative terms, arises if, instead of the spherical element, a cone (with a positive or negative expression) is selected as the shape of the first part.

In a preferred exemplary embodiment, the recess further comprises a second part, which is shaft-shaped or substantially cylindrical, wherein the first part is arranged at an end of the second part facing away from the surface of the light distribution body. In other words, it is preferred that the second part of the recess, which is of shaft-shaped or substantially cylindrical design, extends from the surface of the light distribution body into its interior, and the first part of the recess is arranged at the inner end of the second part. A second part of the light coupling-in surface is formed at the interface between the second part of the recess and the light distribution body (that is to say the lateral surface of the shaft-shaped or substantially cylindrical second part of the recess). In this case, the light coupling-in surface is therefore composed of two parts: a first part, which is formed at the interface between the first part of the recess and the light distribution body, and a second part, which is formed at the interface between the second part of the recess and the light distribution body. It is particularly preferred that a longitudinal axis of the second part of the recess extends substantially along a radial direction of the light distribution body.

In this case, a recess which extends substantially straight along a longitudinal direction is to be understood as being shaft-shaped, wherein the cross section is not necessarily constant.

The advantage which results from the configuration of the recess with the second part is that the radiation emitted by the lighting means is firstly “guided” in the interior of the light distribution body partially by reflection at the lateral surface of the second part of the recess before the radiation passes through that part of the light coupling-in surface which is formed at the first part of the recess.

At the same time, it is possible to control, via a corresponding selection of the depth of the second part of the recess, which portion of the radiation originally emitted by the lighting means is already emitted into the light distribution body before the remaining portion of the emitted radiation enters the first part via that part of the light coupling-in surface which is formed at the first part of the recess.

If the second part is configured to be longer, a larger portion of the incident light beams, the propagation direction of which does not run parallel to the direction of extent of the second part, is coupled into the light distribution body via that part of the light coupling-in surface which consists of the interface between the second part and the light distribution body, as a result of which the portion of the radiation emitted in a diffused manner increases.

According to a further preferred embodiment, the surface of the light coupling-in surface is completely and/or partially roughened and/or frosted.

As a result of a targeted roughening or frosting of the light coupling-in surface, the portion of the radiation emitted in a diffused manner can furthermore be increased in a simple and effective manner since a reflection at the light coupling-in surface is reduced.

According to a further aspect of the invention, the light distribution body has a reflector element and/or scattering centers for modifying the ratio of directed and diffuse emission of the light distribution body. Preferably, the reflector element is formed by a partially or completely reflecting layer, which is arranged in the interior of the light distribution body or at the light coupling-in surface, or within the recess, and completely or partially reflects impinging radiation.

As a result of a reflection of incident light beams at the reflector element, the portion of the radiation emitted in a directed manner can be further reduced, or can be set in a targeted manner by a partial reflection. Depending on the angular position of the reflector element, it is also possible to set which portion of the incident light beams enters the light distribution body at which angle, as a result of which the directed emission characteristic can be influenced further.

As a result of introducing scattering centers into the light distribution body, the portion of the radiation emitted in a diffused manner can additionally be increased. The scattering centers can be introduced into the solid light distribution body, for example by means of irradiation with highly focused laser irradiation.

In a further preferred embodiment, the recess (assigned to the light coupling-in surface) in the light distribution body has a recess depth and a recess diameter, wherein the recess diameter corresponds to the maximum diameter of the recess at an end of the recess facing the lighting means, wherein the recess diameter and the recess depth are each smaller than or equal to the radius of the light distribution body, and wherein the extent of the recess in directions which are orthogonal to the direction of the recess depth is never larger than the recess diameter.

In this case, the recess depth is composed of the depth of the first part of the recess and, if present, the depth of the second part of the recess. In this case, the recess depth is composed of the depth of the first part and, if present, the depth of the second part. In this case, the maximum extent of the recess along a direction which runs parallel to the optical axis is the depth. In the case of a recess with a second, shaft-shaped or cylindrical part, the depth runs along the longitudinal axis of the second part of the recess.

As a result of a matching or selection of the ratio between the recess diameter and the recess depth, the emission characteristic of the light distribution body can be influenced further. In this case, large recess diameters generally lead to a larger portion of radiation emitted in a diffused manner, whereas small recess diameters generally lead to a larger portion of directed emission. As already explained above with regard to the depth of the second element, a larger recess depth likewise leads to a higher portion of radiation emitted in a diffused manner, and a smaller recess depth leads to a higher portion of radiation emitted in a directed manner.

It is furthermore preferred that the recess depth is larger than, preferably (at least) twice as large as, the recess diameter (D).

Embodiments in which the recess diameter is smaller than a quarter of the radius of the light distribution body, preferably smaller than a fifth, more preferably smaller than a tenth, are likewise preferred.

With the selection of a small recess diameter, excessive hollowing out of the solid light distribution body is avoided, and a sufficiently large volume within the light distribution body for light propagation and distribution is created. As a result, the emission characteristic can advantageously be manipulated by means of the configuration of the light distribution body.

According to a preferred embodiment of the invention, the lighting device comprises a light guide which is designed to guide light emitted by the lighting means to the light coupling-in surface of the light distribution body. As a result, the lighting means can be arranged spaced apart from the light distribution body. This can be structurally advantageous. In addition, by means of the light guide, the distance between the lighting means and the light distribution body can be set in a targeted manner by the length of the light guide being correspondingly selected. This can contribute to modifying the emission angle of the directed light portion. As illustrated in a plurality of exemplary embodiments described herein, according to the present invention, light emitted by the lighting means can be guided with or without a light guide to the light coupling-in surface of the light distribution body.

Any optical element with which light can be transported within the light guide between a coupling-in surface and a coupling-out surface of the light guide can be used as a light guide. An optical waveguide can be used, for example, as a light guide. Likewise, elongate, for example cylindrical or prism-shaped elements made of a transparent material such as glass or a transparent plastic can be used as light guides, in which the light emitted by the lighting means is coupled in via a base surface and is coupled out via the axially remote base surface.

According to a further preferred embodiment of the invention, the light exit region of the light distribution body is formed by a frosted surface. Specifically, the light exit region is formed by a frosted surface on a surface of the light distribution body. As a result, a diffuse light exit over the entire light exit region can be provided in a particularly simple manner. The frosting of the light exit region can be generated in a customary manner by roughening of the surface, for example by etching or sandblasting.

In a preferred embodiment, the light distribution body is formed by a solid, substantially spherical body made of a transparent material whose surface is frosted with the exception of the light coupling-in surface. Owing to the spherical shape, a (first) part of the coupled-in light is focused and emerges in a directed manner via a surface region of the light distribution body or a part of the light exit region which lies opposite the light coupling-in surface, respectively. Another (second) part of the coupled-in light emerges in a diffuse manner at the frosted surface of the light distribution body (that is to say at the light exit region) and/or is reflected in a diffuse manner at the frosted surface in the interior of the light distribution body and is subsequently emitted in a diffuse manner via the frosted surface.

In some examples, for example, only a part of the (spherical) surface of the light distribution body can be frosted (or roughened, respectively), for example as described herein.

The frosted and/or non-frosted regions can be configured in such a way that the light emerges, for example, substantially via the frosted regions. For example, no light can emerge via the non-frosted regions.

However, it is also possible for the light emerging in a diffuse manner to emerge (mainly) at the frosted regions of the surface of the light distribution body, and (partially) also at the non-frosted regions.

In exemplary embodiments with a (substantially) completely frosted surface of the light distribution body, for example (as described herein) the second part of the introduced light is scattered by means of the frosted surface of the light distribution body, so that the light emerges in a diffuse manner substantially over the entire (frosted) light exit region of the light distribution body.

In exemplary embodiments in which the surface of the light distribution body comprises frosted and non-frosted parts, the second part of the introduced light can be scattered by means of the light distribution body, in particular the frosted part of the surface of the light distribution body. As a result, the light can emerge in a diffuse manner substantially over the entire (frosted) light exit region of the light distribution body, that is to say, for example, at the frosted and/or in some cases also the non-frosted parts of the surface.

In particular in embodiments with a non-frosted (for example polished) surface of the light distribution body, for example (as described herein) a part of the introduced light can be scattered by means of scattering centers in the interior of the light distribution body, so that the light emerges in a diffuse manner substantially (also) via the non-frosted surface. In examples with a completely non-frosted (for example polished) surface of the light distribution body, a part of the light can thus also emerge over the entire (non-frosted) light exit region of the light distribution body. However, examples with a (completely) non-frosted surface are also conceivable.

A lighting device can thus be formed which provides a particularly advantageous and aesthetically pleasing combination of a diffuse emission characteristic and a directed emission characteristic using only one lighting means, which is particularly simple and inexpensive to produce, and which has a particularly compact construction. It has surprisingly been found that when using a solid, (substantially) spherical light distribution body made of a transparent material with a frosted surface as the light exit region, a lighting device is created in which the intensity of the light portion which is emitted in a diffuse manner by the light distribution body has a satisfactorily high intensity over the entire light exit region, which intensity is suitable for uniform and tuned illumination, while the directed portion of the emitted light is bright enough to illuminate a limited area of space in a spot-like manner.

It is furthermore preferred that the light coupling-in surface is formed by a smoothly ground or polished region at the interface between the recess of the light distribution body and the light distribution body. The coupling-in of light into the light distribution body is thereby facilitated.

The lighting means is preferably formed by one or more LEDs and is furthermore preferably designed as an LED cluster or LED-RGB module. A luminous, energy-efficient and compact lighting means can thus be provided with low production costs. The lighting device preferably has precisely one lighting means which is formed by an (individual) LED or an LED cluster or an LED module. If an LED-RGB module is used as a lighting means, the color of the light emitted by the lighting device can be set in a variable manner. In this case, owing to the internal reflections and scatterings, the light distribution body brings about a mixing of the light colors which are emitted by the individual LEDs of the LED-RGB module. A light emission with a homogeneous color is thereby achieved.

In a (further) preferred embodiment, the light distribution body has regions with a reflection coating on its surface, which is designed to partially or completely reflect light which propagates in the interior of the light distribution body and impinges on the reflection coating.

As a result of the provision of a reflection coating in regions, the emission characteristic of the light distribution body can be modified further in a targeted manner. The emission of directed and/or diffuse light can be restricted, for example, to certain solid angle regions or can be reduced in a targeted manner in certain regions. When a light distribution body with a convex (in particular spherical) shape with a frosted surface is used, surface regions can be excluded from the light exit region by applying a reflection coating with total reflection in regions, since no emergence of light from the light distribution body can take place in these regions.

According to a (further) preferred embodiment, the lighting device comprises a holder in which the light distribution body is mounted rotatably about its center point. As a result, the direction of the directly emitted light can be adapted in a simple manner by the user by the light distribution body being rotated in the holder. Particularly preferred in this embodiment is a substantially spherical light distribution body, since it can be mounted rotatably about its center point in a structurally simple manner.

It is furthermore preferred that the lighting device comprises a dome which partially or completely encloses the light distribution body. As a result, the surface of the light distribution body can be protected from soiling and damage. In particular in the case of light distribution bodies with a frosted surface, this protection is advantageous since contaminations of the frosted surface influence the diffusion effect and can lead to a changed transmission behavior.

According to a preferred development, the dome has surface regions with different transmittance, which are designed to modify the emission characteristic of the light distribution body. Preferably, at least one surface region has a partially reflecting and/or a fully reflecting coating. According to this development, the emission characteristic of the lighting device can be modified by corresponding design of the dome without the light distribution body having to be changed. As a result, suitable emission characteristics of the lighting device can be realized depending on the application. In addition, an aesthetically advantageous configuration of the lighting device can be realized.

The invention is also described in the following with regard to further details, features and advantages which are explained in more detail with reference to the figures. The described features and feature combinations, as shown in the following in the drawings of the figures and described with reference to the drawings, can be used not only in the respectively specified combination, but also in other combinations, without the context of the invention being left thereby.

Herein:

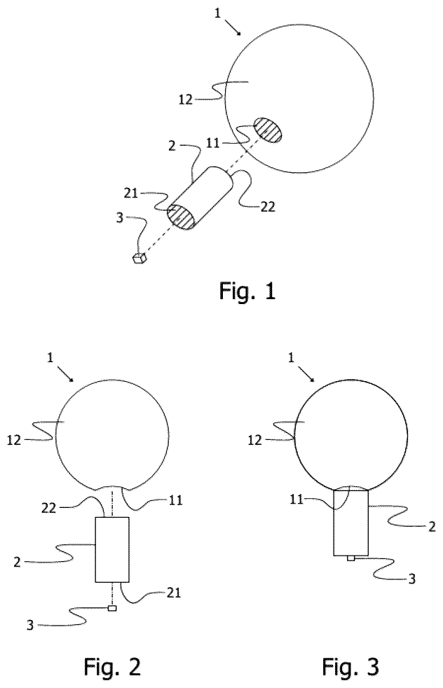

FIG. 1 shows a perspective exploded illustration of a lighting device with a light distribution body according to an exemplary embodiment of the present invention;

FIG. 2 shows an exploded illustration of the lighting device from FIG. 1 in a sectional view;

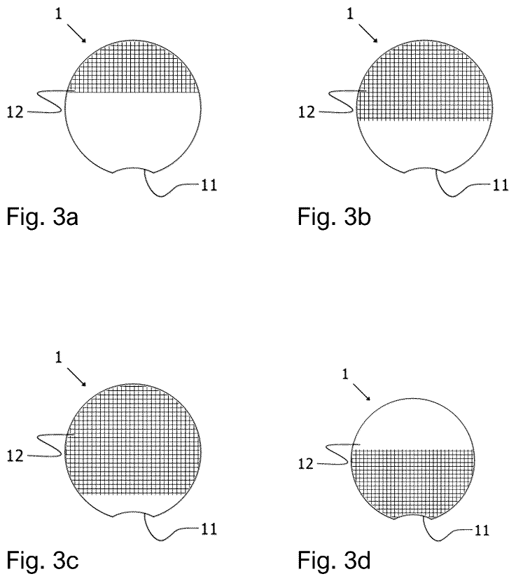

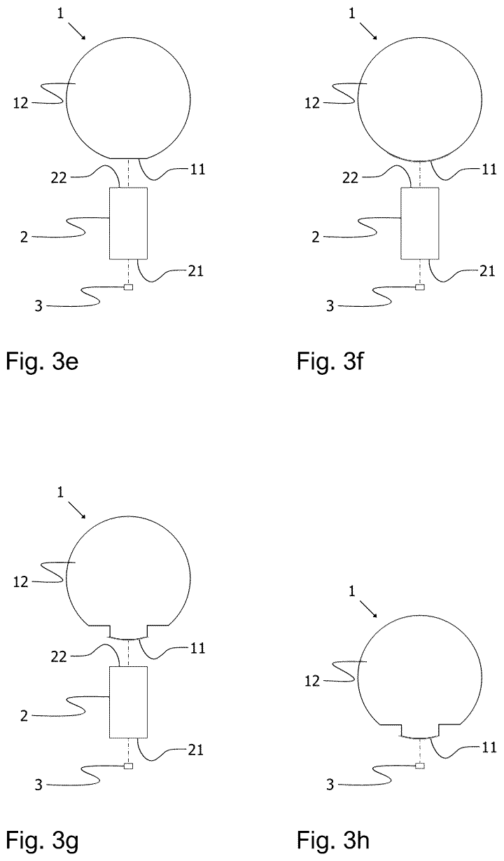

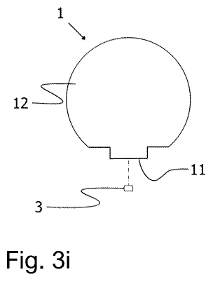

FIG. 3 shows a sectional illustration of the lighting device from FIG. 1 in the assembled state;

FIG. 3a shows an illustration of a first exemplary embodiment with a light distribution body, wherein the frosted surface forming the light exit region of the light distribution body comprises only a part of the surface of the light distribution body;

FIG. 3b shows an illustration of a second exemplary embodiment with a light distribution body, wherein the frosted surface forming the light exit region of the light distribution body comprises only a part of the surface of the light distribution body;

FIG. 3c shows an illustration of a third exemplary embodiment with a light distribution body, wherein the frosted surface forming the light exit region of the light distribution body comprises only a part of the surface of the light distribution body;

FIG. 3d shows an illustration of a fourth exemplary embodiment with a light distribution body, wherein the frosted surface forming the light exit region of the light distribution body comprises only a part of the surface of the light distribution body;

FIG. 3e shows a sectional illustration of the lighting device from FIG. 1 in the assembled state with a planar light coupling-in surface;

FIG. 3f shows a sectional illustration of the lighting device from FIG. 1 in the assembled state with a convex light coupling-in surface;

FIG. 3g shows a sectional illustration of the lighting device from FIG. 1 in the assembled state with a convex light coupling-in surface and a circumferential notch;

FIG. 3h shows an illustration of a fourth exemplary embodiment with the light distribution body from FIG. 3g and without a light guide;

FIG. 3i shows an illustration of a fifth exemplary embodiment with the light distribution body with a planar light coupling-in surface and a circumferential notch;

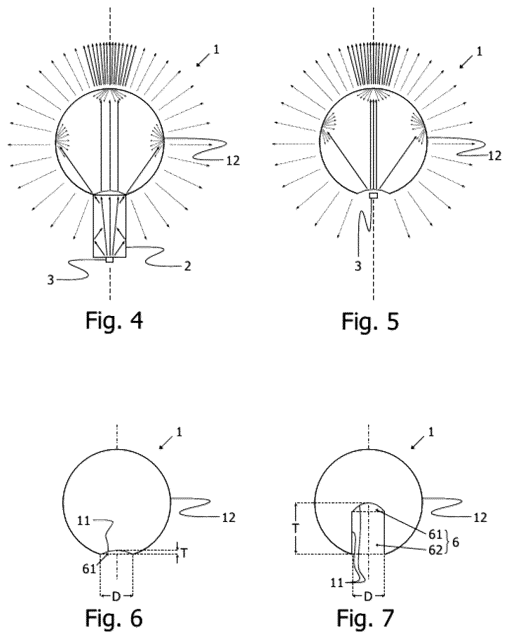

FIG. 4 shows a schematic illustration of the emission characteristic which can be achieved with the lighting device according to the exemplary embodiment shown in FIGS. 1 to 3;

FIG. 5 shows an illustration of a variant of the exemplary embodiment shown in FIG. 4 with a schematic illustration of the achievable emission characteristic;

FIG. 6 shows an illustration of an exemplary embodiment in which the recess consists only of the first part;

FIG. 7 shows an illustration of an exemplary embodiment with a recess consisting of a first and a second part;

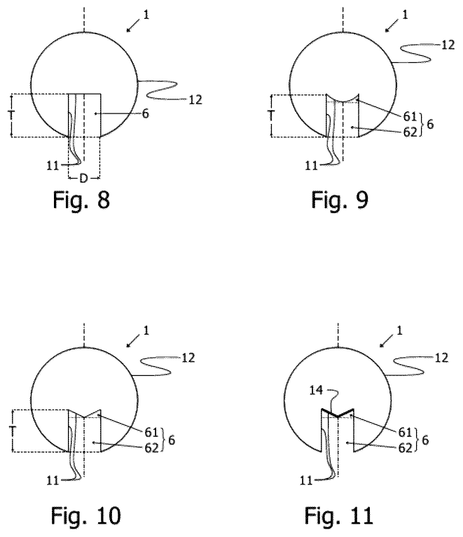

FIG. 8 shows a further exemplary embodiment, wherein the first part consists of a flattening;

FIG. 9 shows an exemplary embodiment in which the first part consists of a negative spherical segment;

FIG. 10 shows an exemplary embodiment in which the first part consists of a negative truncated cone;

FIG. 11 shows an exemplary embodiment having a reflector element at the light coupling-in surface.

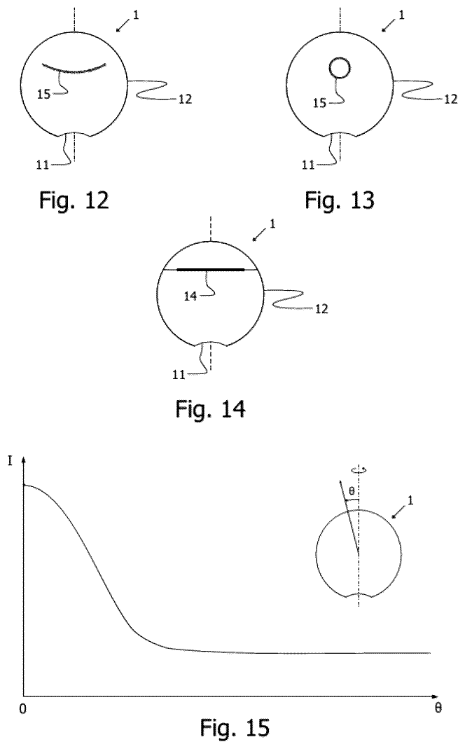

FIGS. 12 & 13 show exemplary embodiments with different arrangements of scattering centers in the light distribution body.

FIG. 14 shows an arrangement having a reflector element in the light distribution body;

FIG. 15 shows a graph which qualitatively represents the angle dependence of the emission characteristic which can be generated with the lighting devices shown in FIGS. 4 and 5;

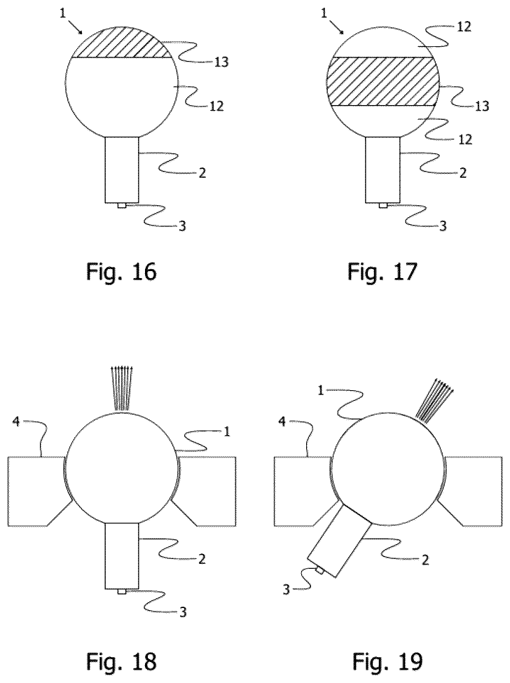

FIG. 16 shows a schematic sectional view of a lighting device with a light distribution body according to a further preferred exemplary embodiment of the present invention with modified emission characteristic;

FIG. 17 shows a schematic sectional view of a lighting device with a light distribution body according to a further preferred exemplary embodiment of the present invention with modified emission characteristic;

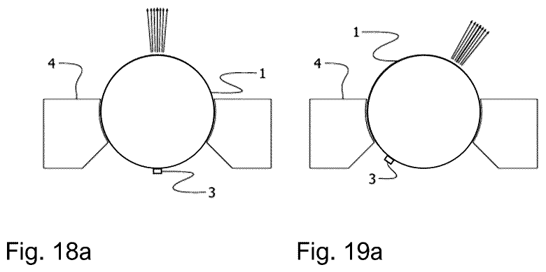

FIGS. 18 & 19 show a schematic sectional view of a lighting device with a light distribution body according to a further preferred exemplary embodiment of the present invention with a holder for the light distribution body;

FIGS. 18a & 19a show a schematic sectional view of a lighting device according to FIGS. 18 & 19, wherein the lighting device comprises no light guide;

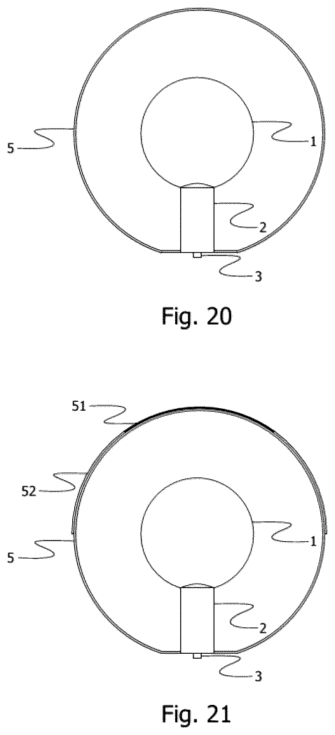

FIG. 20 shows a schematic sectional view of a lighting device with a light distribution body according to a further preferred exemplary embodiment of the present invention with a dome;

FIG. 21 shows an illustration of a variant of the exemplary embodiment shown in FIG. 20.

The figures are merely schematic in nature and serve exclusively for understanding the invention. Identical or similar elements are provided with the same reference signs in the description of the exemplary embodiments.

FIG. 1 shows a perspective exploded illustration of a lighting device according to a preferred exemplary embodiment of the present invention. The lighting device comprises, as main components, a light distribution body 1, a light guide 2 and a lighting means 3.

The lighting means 3 is preferably formed by an LED or an LED unit composed of a plurality of LEDs, for example an LED cluster or an LED module, but is not restricted thereto. The lighting means 3 is designed to emit light in the direction of the light guide 2 and of the light distribution body 1 connected thereto.

The light guide 2 is formed by an elongate, substantially cylindrical body made of a transparent material whose longitudinal axis extends along a central axis of the lighting device. The central axis is illustrated as a dash-dotted line in the exploded illustration of FIG. 1. At the axial ends, the light guide 2 has in each case a light coupling-in surface 21 and a light coupling-out surface 22. The light coupling-in surface 21 and the light coupling-out surface 22 are preferably surfaces with a high transmittance, which can be achieved, for example, by corresponding polishing and/or application of a suitable coating. The lateral surface of the light guide 2 can be provided with a suitable reflection coating in order to improve the light transmission between the lighting means 3 and the light distribution body 1. Alternatively, the lateral surface of the light guide 2 can be provided with an opaque cover. It is likewise possible for the lateral surface of the light guide 2 not to have any particular modification and to be formed by an untreated or not specially treated surface.

The light guide 2 serves to guide light emitted by the lighting means 3 into the light distribution body 1. For coupling-in of the light into the light distribution body 1, the latter has a light coupling-in surface 11. In the assembled state, the light guide 2 is placed with the light coupling-out surface 22 on the light coupling-in surface 11. This can be seen in FIGS. 2 and 3, which show a schematic sectional illustration of the lighting device from FIG. 1. The lighting means 3 is placed on the light coupling-in surface 21 of the light guide. The light coupling-out surface 22 of the light guide 2 is placed on the light coupling-in surface 11 of the light distribution body 1. Thus, light emitted by the lighting means 3 is coupled into the light guide 2 via the light coupling-in surface 21. The light is then guided in the light guide 2 to the light coupling-in surface 11 of the light distribution body 1. The light is finally coupled into the light distribution body 1 from the light coupling-out surface 22 of the light guide 2 via the light coupling-in surface 11 of the light distribution body 1.

The light distribution body 1 in the exemplary embodiment shown in FIGS. 1 to 3 has a convex shape. Specifically, the light distribution body 1 illustrated there is substantially spherical. The shape of the light distribution body 1 deviates from a spherical shape only at the light coupling-in surface 11. The light coupling-in surface 11 in the exemplary embodiment shown in FIGS. 1 to 3 is formed at a depression of the light distribution body 1.

The light distribution body 1 is solid and is formed from a transparent material such as, for example, glass or transparent plastic. Glass is preferred as material for the light distribution body 1. For emitting the coupled-in light, the light distribution body 1 has a light exit region 12 at its surface. In the case of the substantially spherical light distribution body 1 shown in FIGS. 1 to 3, the light exit region 12 is formed substantially by the entire surface of the light distribution body 1 with the exception of the light coupling-in surface 11.

The light exit region 12 of the light distribution body shown in FIGS. 1 to 3 is formed by a frosted or satinized surface, that is to say a finely roughened surface, at which light is scattered in a diffuse manner in the interior of the light distribution body 1 and through which light emerges in a diffuse manner from the interior of the light distribution body 1. Such a surface can be obtained in the case of a light distribution body 1 made from glass, for example by sandblasting or etching.

FIGS. 3a-3d show different exemplary embodiments according to FIG. 3 with a light distribution body 1, wherein the frosted surface forming the light exit region 12 of the light distribution body 1 comprises only a part of the surface of the light distribution body 1: In detail, different partial regions of the surface of the light distribution body 1, for example as described herein, can be frosted: In the examples of FIGS. 3a-3c, the frosted portion is illustrated by the square-patterned surface and the portion thereof increases from FIG. 3a to FIG. 3c. The frosted portion of the surface of the light distribution body 1 can, on the one hand, comprise, for example, at least a first predetermined portion of the surface of the light distribution body 1 and/or be, for example, 25% or more, 50% or more or 75% or more. The frosted portion of the surface of the light distribution body 1 can, on the other hand, comprise, for example, at most a second predetermined portion of the surface of the light distribution body 1 and/or be, for example, 90% or less, 75% or less or 60% or less. Whereas, in FIGS. 3a-3c, the partial region of the surface of the light distribution body 1 lying substantially opposite the light coupling-in surface 11 is frosted, in the example of FIG. 3d, the partial region of the surface of the light distribution body 1 adjoining the light coupling-in surface 11 is frosted. Substantially, a similarly large partial region of the surface of the light distribution body 1 is frosted in the example of FIGS. 3b and 3d. By means of arrangements as shown by way of example in FIG. 3d, for example, the portion of the emission of directed light can be increased relative to the light emitted in a diffused manner.

Preferably, the frosted portion of the surface lies substantially opposite the light coupling-in surface 11, for example rotationally symmetrically (as illustrated, for example, in FIGS. 3a-3d). Furthermore, in other exemplary embodiments, the frosted region can be oriented arbitrarily relative to the light coupling-in surface 11, for example not rotationally symmetrically.

The transition between the one or more frosted portions of the surface of the light distribution body 1 to the one or more non-frosted portions of the surface of the light distribution body 1 can be configured directly, for example (within the context of the manufacturing accuracy), or comprise a smooth transition, for example with a width of 1 mm to 10 mm, preferably of 2 mm to 5 mm. The borders of the portions of the surface of the light distribution body 1 can run substantially on circular paths (as shown in FIGS. 3a-3d) or have any other desired profiles, for example angular and/or curved profiles.

FIGS. 3e-3h show embodiments of the light coupling-in surface 11 which deviate from the embodiment shown in FIG. 3: in detail, FIG. 3e shows a sectional illustration of the lighting device with a planar light coupling-in surface 11, FIG. 3f shows a sectional illustration of the lighting device with a convex light coupling-in surface 11 and FIGS. 3g and 3h show a sectional illustration of the lighting device with a convex light coupling-in surface 11 and a circumferential notch (illustrated in this example by a right-angled notch which runs in a circular manner around the light coupling-in surface 11). The notch, as illustrated, for example, in FIG. 3g, can be configured to attach the light distribution body 1 to a further device, for example the light guide 2 and/or a mount running around the notch. The mount and the light distribution body can be configured, for example, in such a way that they can be releasably connected to one another by means of a screw connection. For example, the cylindrical extension formed by the notch can be provided with an external thread for this purpose. The mount can be connected, for example, to further elements of a lighting device, for example the light source.

FIGS. 3h and 3i show illustrations of an exemplary embodiment with the light distribution body 1 without a light guide 2. In principle, all embodiments described herein can be implemented with (as shown, for example, in FIGS. 3e-3g) or without a light guide 2 (as shown, for example, in FIGS. 3h and 3i). In this case, FIG. 3h shows an illustration of a fourth exemplary embodiment with the light distribution body 1 from FIG. 3g and without a light guide 2. FIG. 3i shows an illustration of a fifth exemplary embodiment with the light distribution body 1 with a planar light coupling-in surface 11 and a circumferential notch.

With the lighting device according to the exemplary embodiment shown in FIGS. 1 to 3, an emission characteristic can be generated which contains both a directed portion and a diffuse portion. This is explained in the following with reference to FIGS. 4, 5 and 15.

FIG. 4 is a schematic illustration of the emission characteristic which can be achieved with the lighting device according to FIGS. 1 to 3. FIG. 5 shows a variation of the exemplary embodiment shown in FIGS. 1 to 3 without a light guide 2, with which an emission characteristic with a directed and diffuse portion can likewise be obtained.

Firstly, the emission characteristic of the lighting device with the configuration according to FIG. 4 is explained. Light which is emitted by the lighting means 3 is guided into the light distribution body 1 via the light guide 2. Exemplary beam paths through the light guide 2 are illustrated schematically by the arrows in the light guide 2. The lighting means 3 does not emit collimated light, but rather emits light over a certain angular range. In this case, reflections on the inner wall of the light guide 2 can also occur. Light which is coupled into the light distribution body 1 from the light guide 2 therefore enters the light distribution body 1 at different angles.

Since the light distribution body 1 is formed solidly from a transparent material, a first part of the coupled-in light, which enters the light distribution body 1 at a sufficiently small angle with respect to the central axis, illustrated in a dash-dotted manner, of the lighting device, is partially collimated or directed, respectively. This (first) part of the coupled-in light emerges in a directed manner from the light distribution body 1 in a region of the light exit region 12 which lies opposite the light coupling-in surface 11. This is illustrated in FIG. 4 by the solid arrows at the upper end of the light distribution body 1, which represent the directed portion of the emitted light.

A second part of the coupled-in light—namely substantially the light which does not emerge in a directed manner in the region of the light exit region 12 which lies opposite the light coupling-in surface 11—emerges in a diffuse manner from the light distribution body over the entire light exit region 12. As is illustrated conceptually in FIG. 4 by the small dotted arrows in the interior of the light distribution body 1, part of the light which impinges on the frosted surface from the interior is reflected in a diffuse manner back into the interior of the light distribution body 1. As a result, the second part of the coupled-in light is distributed uniformly over the light distribution body 1 and emerges in a diffuse manner substantially over the entire light exit region 12 of the light distribution body 1. This is illustrated in FIG. 4 by the dotted arrows on the surface of the light distribution body 1, which represent the diffuse portion of the emitted light. Owing to the frosted surface, an additional scattering takes place when the light emerges from the light exit region 12.

In the exemplary embodiment shown in FIG. 5, there is no light guide 2. Here, the light emitted by the lighting means 3 is coupled into the light distribution body 1 directly via the light coupling-in surface 11. However, the generation of directed and diffuse light takes place substantially analogously to the exemplary embodiment shown in FIG. 4 and described above. In turn, a (first) part of the coupled-in light is directed by the collimating action of the solid light distribution body 1 and emerges in a directed manner via a part of the light exit region 12 which lies opposite the light coupling-in surface 11. A (second) part of the coupled-in light (substantially the part which does not emerge in a directed manner from the light distribution body 1) is distributed over the light distribution body 1 by internal reflections at the frosted surface and emerges in a diffuse manner through the frosted surface substantially over the entire light exit region 12.

The emission characteristic which can be achieved with the lighting device according to the present invention and in particular with the lighting devices shown in FIGS. 4 and 5 is formed from the superposition of a diffuse portion and a directed portion. This is illustrated schematically in the graph in FIG. 15. The polar angle θ of a spherical coordinate system with origin in the center point of the light distribution body 1 is illustrated on the x-axis. A value of 0° denotes the direction along the central axis of the lighting device away from the light coupling-in surface 11. The intensity of the light which is emitted at the respective angle θ is specified without a specific unit on the y-axis.

The (first) portion of the emitted light which forms the directed portion emerges via a region of the light exit region 12 which lies opposite the light coupling-in surface 11. This directed light exit is represented in FIG. 15 as an increased emission intensity at small values of θ. The (second) portion of the emitted light which forms the diffuse portion is emitted in a diffuse manner substantially over the entire light exit region 12 and manifests itself as a constant background in the graph in FIG. 15.

Overall, with the lighting device according to the invention, an emission characteristic is therefore generated with a directed portion for the targeted illumination of a limited area of space and a diffuse portion for the uniform illumination of a large area of space. In other words: the lighting device according to the invention is suitable for generating a spot illumination with a very soft spot which merges into a diffuse illumination portion which is emitted over virtually the full angle of space. Surprisingly, the intensity of the diffuse portion in this case is so high that the diffuse portion permits tuned uniform illumination. At the same time, the intensity of the directed portion is so high that the directed portion generates a significantly lighter, soft spot with which a limited area of space can be illuminated in a targeted manner.

The lighting device according to the invention emits both directed and diffuse light from the light distribution body 1, wherein only a single lighting means 3 is required for this purpose. In addition, only one compact optical element is required for generating the emission characteristic with a directed and a diffuse portion. The light distribution body 1 generates from the coupled-in light both a directed portion of emitted light over a limited solid angle range and a diffuse portion of emitted light which is emitted over a very large solid angle range.

By simple modifications of the light distribution body 1, the emission characteristic described with reference to FIGS. 4, 5 and 15 can be changed in a suitable manner depending on the illumination requirement. If it is desired, for example, that no light is emitted over a certain solid angle range, corresponding regions of the surface of the light distribution body 1 can be excluded from the light exit region 12 by applying a cover or a reflection coating with total reflection. The use of a reflection coating is preferred in this case, since the luminous efficiency can thus be improved. Light which is reflected at the reflection coating in the interior of the light distribution body 1 can furthermore emerge from the light distribution body 1 via the light exit region 12.

FIG. 6 shows an exemplary embodiment of a light distribution body 1 according to the invention with a light exit region 12. In FIGS. 4 to 14, the dash-dotted line shows an axis of rotational symmetry of the light distribution body 1. In the exemplary embodiment according to FIG. 6, the recess 6, at the interface of which the light coupling-in surface 11 is formed with the light distribution body 1, consists only of a first part 61. The first part 61 is formed here by a positive spherical segment. As a result of this configuration of the first part 61, the incident light is refracted in such a way that previously parallel-running light beams diverge on entry into the light distribution body 1. As a result, the portion of the light emitted in a directed manner is reduced. The recess depth T and the recess diameter D of the recess 6 are designated with the corresponding reference signs in FIG. 6 and emerge from the dimensions of the recess 6 (which in the present exemplary embodiment consists only of the first part 61).

FIG. 7 shows a further exemplary embodiment of a light distribution body 1 according to the invention with a light exit region 12. In this exemplary embodiment, the recess 6, the interface of which with the light distribution body 1 forms the light coupling-in surface 11, consists of a first part 61 and a second part 62. The recess depth T is composed of the depth of the first part 61 and of the second part 62. The recess diameter D emerges from the dimensions of the second part 62. The first part 61 is also formed here by a positive spherical segment. As a result, and as a result of light beams which do not run exactly parallel to the optical axis already being able to emerge into the light distribution body 1 via that part of the light coupling-in surface 11 which adjoins the second part 62, the portion of radiation emitted in a diffused manner once again increases in the emission characteristic. In the exemplary embodiment shown here, the recess depth T corresponds to just the radius of the light distribution body 1. The recess diameter D shown is in this case significantly smaller than the radius of the light distribution body 1. In the embodiment shown, the recess diameter D corresponds to just a third of the radius of the light distribution body 1. FIG. 8 shows a further exemplary embodiment of the light distribution body 1 with a light coupling-in surface 11 and a light exit region 12, in which the first part 61 is formed by a flattening and thus has substantially no depth. In this case, this recess depth T is defined substantially by the second part 62 of the recess 6. As a result of the configuration of the first part 61 as a flattening, light beams running parallel to the optical axis are not refracted on entry into the light distribution body 1, which increases the portion of the radiation emitted in a directed manner. As can be seen here, the recess diameter D is substantially half the size of the recess depth T. In this case, the recess diameter D corresponds to just a third of the radius of the light distribution body.

FIG. 9 shows a further exemplary embodiment of the light distribution body 1 with a light exit region 12. In this exemplary embodiment, the recess 6, the interface of which with the light distribution body 1 forms the light coupling-in surface 11, consists of a first part 61 and a second part 62. The recess depth T thus results from the depth of the first part 61 and of the second part 62 in combination. The recess diameter D thus results from the dimensions of the second part 62. The embodiment shown is largely analogous to that in FIG. 7, but here the first part 61 is formed by a negative spherical segment. As a result, that part of the light coupling-in surface 11 which is formed at the interface of the light distribution body 1 and of the first part 61 of the recess acts in a collimating manner on the incident light beams, as a result of which the portion of the radiation emitted in a directed manner increases. The first part 61 of the recess 6 is formed by the region which adjoins the negatively shaped spherical segment.

FIG. 10 shows a further exemplary embodiment of the light distribution body 1 with a light exit region 12. In this exemplary embodiment, the recess 6, the interface of which with the light distribution body 1 forms the light coupling-in surface 11, consists of a first part 61 and a second part 62. The embodiment shown is largely analogous to those in FIGS. 7 to 9, but here the first part 61 is formed by a negative conical segment. The action of the light coupling-in surface 11 is therefore similar to that which has been described with reference to FIG. 9. Thus, the portion of the radiation emitted in a directed manner is also increased in this exemplary embodiment.

FIG. 11 is a further modification of the exemplary embodiment shown in FIG. 10. Here, a reflector element 14 is also fitted on the light coupling-in surface as an additional feature. Incident beams are reflected back sideways by the reflector element 14, which reduces the portion of the radiation emitted in a directed manner. This portion can be set by varying the transmittance of the reflector element 14.

FIG. 12 shows a modification of the exemplary embodiment shown in FIG. 6, in which scattering centers 15 are introduced into the light distribution body in a semicircular pattern in order to influence the emission characteristic in a large angular range. FIG. 13 shows a further exemplary embodiment, in which a different distribution of the scattering centers 15 is selected. The scattering centers 15 bring about a diffuse distribution of the light in the light distribution body 1 and increase the portion of radiation emerging in a diffused manner.

In particular in exemplary embodiments in which scattering centers 15 are located in the light distribution body, the surface of the light distribution body 1 can be completely or at least partially non-frosted.

FIG. 14 shows an exemplary embodiment 6, in which a reflector element 14 is introduced into the body of the light distribution body 1 in order to reduce the portion of the light emerging in a directed manner. The reflector element 14 can be designed to be partially reflecting or fully reflecting depending on the desired intensity of the radiation emitted in a directed manner.

FIGS. 16 and 17 show two schematic views of a lighting device with correspondingly modified light distribution body 1. The light distribution bodies 1 in FIGS. 16 and 17 are provided with a reflection coating 13 in regions. In the region of the reflection coating 13, no light emerges from the light distribution body 1, with the result that the regions with reflection coating 13 do not form a part of the light exit region 12.

In the configuration shown in FIG. 16, a region of the surface of the light distribution body opposite the light coupling-in surface 11 is provided with a reflection coating 13. With this configuration, the portion of directed light is greatly suppressed. The remaining light exit region 12 emits substantially diffuse light which was partly reflected at the reflection coating 13 in the interior of the light distribution body.

In the configuration shown in FIG. 17, a reflection coating 13 is applied over an annular region of the surface of the light distribution body 1. With this configuration, a superposition of directed and diffuse light is emitted in a region of the light exit region 12 which lies opposite the light coupling-in surface 11. A further part of the light exit region 12 adjoins the light coupling-in surface 11 and serves to emit diffuse light. Between the two parts of the light exit region 12, a region in which no light is emitted is formed with the reflection coating 13.

Instead of a reflection coating 13, a tint in regions can also be provided on the surface of the light distribution body 1 or a coating with reduced transmittance. The exemplary embodiments with modified emission characteristic shown in FIGS. 16 and 17 can also be combined with the configuration of the lighting device without a light guide 2 illustrated in FIG. 5.

The portion of the light which is coupled into the light distribution body 1 and is emitted in a directed manner is emitted via a surface region which lies opposite the light coupling-in surface 11 when a substantially spherical light distribution body 1 is used. In order to be able to set the direction of the directed light portion, the lighting device can be held in a movable manner. It is particularly preferred in this case to hold the lighting device in such a way that the light distribution body 1 is mounted rotatably about its center point. With such a mounting, the direction of the directly emitted light can be changed by rotation of the light distribution body 1 without the light distribution body 1 changing its absolute position.

This is illustrated in FIGS. 18 and 19. According to this exemplary embodiment, the lighting device is mounted in a schematically shown holder 4 in such a way that the light distribution body 1 is rotatable about its center point. In the position shown in FIG. 18, the directed light portion which is emitted by the lighting device is emitted perpendicularly upwards. If the light distribution body 1 is rotated in the holder, the direction of the directly emitted light changes, as is illustrated in FIG. 19. However, the position of the light distribution body 1 remains unchanged. A lighting device with a small space requirement can thus be created which has an emission characteristic with a diffuse portion and a directed portion, wherein the emission direction of the directed portion is adjustable.

The configuration with a holder shown in FIGS. 18 and 19 can be combined both with the configuration without a light guide 2 shown in FIG. 5 and with a light distribution body 1 with modified emission characteristic according to the exemplary embodiments described with reference to FIGS. 16 and 17.

FIGS. 18a & 19a show an analogous schematic sectional view of a lighting device, wherein the lighting device comprises no light guide. This serves to illustrate that even exemplary embodiments with a rotatably mounted light distribution body can be implemented with or without a light guide 2.

In order to protect the light distribution body 1 and in particular the frosted surface thereof from contaminations and damage, the lighting device can comprise a (transparent) dome which at least partially encloses the light distribution body 1. Such a configuration is illustrated in FIG. 20. The lighting device comprises, in addition to the light distribution body 1, the light guide 2 and the lighting means 3, a dome 5 which surrounds the light distribution body 1. In order to improve the overall aesthetic impression, it is preferred in this exemplary embodiment if the lateral surface of the light guide 2 is provided with an opaque cover or coating (not shown). As a result, the visibility of the light guide 2 is reduced, with the result that the optical impression arises that the light distribution body 1 floats in the interior of the dome 5.

In order to modify the emission characteristic of the lighting device according to FIG. 20, the dome 5 can be provided with coatings with reduced transmittance in regions. This is illustrated schematically in FIG. 21. The dome 5 has a first (partially) reflecting coating 51 in an upper region, and a second (partially) reflecting coating 52 in an annular region around the upper region. The transmittances of the coatings 51, 52 differ from one another. Coatings with a transmittance of 0 can be used, that is to say fully reflecting coatings, or partially reflecting coatings with a transmittance of between 0 and 1. Likewise, a tint in regions of the dome 5 can be used in order to modify the emission characteristic of the lighting device.

If, in the exemplary embodiment shown in FIG. 21, the first coating 51 is implemented as a fully reflecting coating and the second coating 51 is implemented as a partially reflecting coating, the directed portion of the light emitted by the light distribution body 1 is reflected substantially completely at the first coating 51. A portion diffusely emitted by the light distribution body 1 emerges through the region of the second coating 52, the intensity of which portion is reduced by the second coating 52. A glare-free lighting device with a diffuse emission characteristic over a limited area of space is thus created.

The configuration of the coatings 51, 52 shown in FIG. 21 is purely exemplary. It is obvious to the person skilled in the art that any desired combination and arrangement of coatings and/or tinted regions on the dome 5 can be used to achieve a desired modification of the emission characteristic of the lighting device. The dome 5 can additionally be configured in a removable and exchangeable manner. As a result, the emission characteristic of the lighting device can be modified by simply exchanging the dome 5 for a dome with a different configuration of the coatings and/or tintings, without a modification or change of the light distribution body 1 or of the lighting means 3 being required.

It is apparent for the person skilled in the art that the exemplary embodiments shown in FIGS. 20 and 21 with the dome 5 can be combined with the other described exemplary embodiments of the light distribution body 1.

### LIST OF REFERENCE SIGNS

1 Light distribution body
11 Light coupling-in surface
12 Light exit region
13 Reflection coating
14 Reflector element
15 Scattering centers
2 Light guide
21 (second) light coupling-in surface
22 Light coupling-out surface
3 Lighting means
4 Holder
5 dome
51 first (partially) reflecting coating
52 second (partially) reflecting coating
6 recess
61 first part of the recess
62 second part of the recess
T Recess depth
D Recess diameter

1. A lighting device, in particular for illuminating an interior, comprising:
a lighting means (3);
a light distribution body (1) having a light coupling-in surface (11) and a translucent light exit region (12);
wherein the light distribution body (1) is substantially spherical and is designed to emit a first part of the light emitted by the lighting means (3) and introduced into the light distribution body (1) via the light coupling-in surface (11) in a directed manner, and to scatter a second part of the introduced light by means of the light distribution body (1), so that the light emerges in a diffuse manner substantially over the entire light exit region (12) of the light distribution body (1), wherein the light distribution body (1) is of solid design, and wherein the light coupling-in surface (11) is the interface between a recess (6) of the light distribution body (1) and the light distribution body (1).

2. The lighting device according to claim 1, wherein the recess (6) comprises a first part (61), which preferably has the shape of a spherical element, a cone or a flattening, wherein the shape can be both positive and negative.

3. The lighting device according to claim 1, wherein the recess (6) comprises a second part (62), which is shaft-shaped or substantially cylindrical, wherein the first part (61) is arranged at an end of the second part facing away from the lighting means (3).

4. The lighting device according to claim 1, wherein the surface of the light coupling-in surface (11) is completely and/or partially roughened and/or frosted.

5. The lighting device according to claim 1, comprising
a reflector element (14) for modifying the ratio of directed and diffuse emission of the light distribution body (1), wherein the reflector element (14) is formed by a partially or completely reflecting layer, which is arranged in the interior of the light distribution body (1) or at the light coupling-in surface (11); and/or
scattering centers (15) for modifying the ratio of directed and diffuse emission of the light distribution body (1), wherein the scattering centers (15) are formed in the interior of the light distribution body (1).

6. The lighting device according to claim 1, wherein the recess (6) in the light distribution body (1) has a recess depth (T) and a recess diameter (D), wherein the recess diameter (D) corresponds to the maximum diameter of the recess (6) at an end of the recess (6) facing the lighting means, wherein the recess diameter (D) and the recess depth (T) are each smaller than or equal to the radius of the light distribution body.

7. The lighting device according to claim 1, wherein the recess depth (T) is larger than, preferably twice as large as, the recess diameter (D).

8. The lighting device according to claim 1, wherein the recess diameter (D) is smaller than a third of the radius of the light distribution body (1), preferably smaller than a quarter, more preferably smaller than a fifth, more preferably smaller than a tenth.

9. The lighting device according to claim 1, comprising a light guide (2) which is designed to guide light emitted by the lighting means (3) to the light coupling-in surface (11) of the light distribution body (1).

10. The lighting device according to claim 1, wherein the light exit region (12) of the light distribution body (1) is formed by a frosted surface.

11. The lighting device according to claim 1, wherein the light coupling-in surface (11) is formed by a smoothly ground or polished region on the surface of the light distribution body (1).

12. The lighting device according to claim 1, wherein the lighting means (3) is formed by one or more LEDs and is preferably designed as an LED cluster or LED-RGB module.

13. The lighting device according to claim 1, wherein the light distribution body (1) has regions with a reflection coating (13) on its surface, which is designed to partially or completely reflect light which propagates in the interior of the light distribution body (1) and impinges on the reflection coating (13).

14. The lighting device according to claim 1, comprising a holder (4) in which the light distribution body (1) is mounted rotatably about its center point.

15. The lighting device according to claim 1, comprising a dome (5) which encloses the light distribution body (1), wherein the dome (5) preferably has surface regions (51, 52) with different transmittance, which preferably have partially reflecting coatings and are designed to modify the emission characteristic of the light distribution body (1).
